(19) United States
(12) Patent Application Publication
(10) Pub. No.: US 2010/0015392 A1
(43) Pub. Date: Jan. 21, 2010

(54) SYSTEM AND METHOD FOR FORMING PLASTIC PALLETS

(75) Inventors: Frank W. Bradish, Kingsville, OH (US); Charles E. Kappelt, Linesville, PA (US)

Correspondence Address: HAHN LOESER & PARKS, LLP, One GOJO Plaza, Suite 300, AKRON, OH, 44311-1076, US

(73) Assignee: MOLDED FIBER GLASS COMPANIES, Ashtabula, OH (US)

(21) Appl. No.: 12/569,438

(22) Filed: Sep. 29, 2009

Related U.S. Application Data
(63) Continuation-in-part of application No. 12/267,012, filed on Nov. 7, 2008.
(60) Provisional application No. 60/986,790, filed on Nov. 9, 2007.

(51) Int. Cl. B32B 3/12; B29C 47/06; B32B 3/26

(52) U.S. Cl. 428/116; 264/176.1; 428/192; 425/224; 425/131.1

(57) ABSTRACT

A preformed pallet is provided having first and second outer layers that sandwich a cellular or honeycomb shaped core. The peripheral edge of the preformed pallet may be inserted into the molding device having one or more heating elements, which function to focus heat onto the peripheral edge. Once heated, the peripheral edge of the preformed pallet may be reshaped by one or more die sets forming the peripheral edge into an enclosed pallet.

This patent application is a continuation-in-part of patent application Ser. No. 12/267,012 filed on Nov. 7, 2008, which claims priority to U.S. provisional patent application Ser. 60/986,790 filed on Nov. 9, 2007, both of which are incorporated herein by reference in their entirety.

### TECHNICAL FIELD

The present invention pertains to pallets for transporting food related and other products, and more specifically to methods and equipment for reshaping a plastic slip pallet.

### BACKGROUND OF THE INVENTION

Shipping pallets are well known for transporting materials in various industries. Millions of pallets are in widespread use today. Wooden pallets, in particular, have provided a platform on which numerous types of goods have been stored, transported and distributed. In one instance, food related industries have used wooden pallets. Such pallets are well suited for stacking and transporting products. They allow for the efficient storage and easy handling of bundled products.

However, while wooden pallets work well to store and transport materials, they are not well suited for use in environments requiring more sanitary conditions. Wood absorbs and holds in contaminants. It contains cracks and other imperfections in the surface where dirt and micro-organisms readily accumulate. As a result, mold, bacteria and parasites grow and live on the pallet surfaces. Constant cleaning or fumigation is required to maintain adequate health standards. For example, fish and meat are easily contaminated by simple contact with a pallet. Additionally, splinters of wood picked up by the food products being transported also pose a significant health risk.

To address the problems of utilizing wooden pallets, technology has afforded a more sanitary solution in recent years, namely the use of plastics in constructing pallets. Polypropylene is one type of plastic well suited for this application. The surface is impervious to contaminants, unlike wood, and is easily cleaned and sanitized. But, the cost of producing plastic pallets can be quite high in some cases up to ten times as much as their wooden counterparts.

The process of producing plastic pallets is also somewhat complex and typically requires the use of ovens, conveyors and compression presses, along with molds and other tooling. One method of producing a plastic pallet uses a cellular or honeycomb core sandwiched between two or more layers of sheet material. The sandwich laminate increases the stiffness and strength of the plastic pallets, while at the same time decreases weight. The materials are typically loaded into the oven on a conveyor and subsequently into a mold where they are compressed or thermoformed thereby fusing the skins and the core material together. The primary purpose of the honeycomb core is to distribute stresses over a relatively large surface area. As a result, the structure resists bending and deforming under load.

Still, the initial investments are significant requiring the purchase, setup and operation of expensive machinery. It would be advantageous to provide a system and method for forming the plastic pallets that utilizes less expensive equipment that is easy to use and operate. The embodiments of the subject invention obviate the aforementioned problems.

### BRIEF SUMMARY

In one embodiment of the subject invention, a method of forming a plastic pallet includes the steps of providing a preformed laminate having one or more peripheral edges, heating the region proximate to the one or more peripheral edges, and compressing the heated region thereby forming a contoured pallet.

In one aspect of the embodiments of the subject invention, the preformed laminate comprises the first and second outer layers that sandwich an inner core, which may have a cellular configuration and more specifically, a honeycomb configuration.

In another aspect of the embodiments of the subject invention, the inner core may be comprised of a plurality of cells contiguously formed into a unitary article.

In still another aspect of the embodiments of the subject invention, the preformed laminate is constructed from a moldable polymer, which may be a thermoplastic and in particular, polypropylene.

In another embodiment of the present invention, a method of forming a pallet for transporting or storing associated objects includes the steps of: providing one or more sheets of generally planar material for supporting one or more associated objects where the one or more sheets define at least a first peripheral edge, and heating a portion of the one or more sheets of generally planar material for changing the shape of the pallet, and reshaping at least part of the pallet.

In one aspect of the embodiments of the subject invention the method includes heating a localized region proximate to the at least a first peripheral edge for changing the shape of the pallet, and reshaping the at least a first peripheral edge of the pallet.

In another embodiment of the subject invention, a system for reshaping an associated laminate having a peripheral edge includes a heating apparatus for applying energy to a localized region having a heating chamber configured to surround a portion of the associated laminate, the heating apparatus having at least one heating element operable to deliver energy into the heating chamber for reshaping the peripheral edge of the associated laminate. The system also include means for applying reshaping force to the peripheral edge of an associated preformed laminate.

In one aspect of the embodiments of the subject invention, the system the heating chamber is generally longitudinal and has a fixed depth. Additionally, the heating chamber includes a slot through which a portion of the associated laminate is inserted into the heating chamber.

In another embodiment of the subject invention, a method of reshaping a preformed moldable pallet includes the steps of providing one or more sheets of material (which may be moldable) separated by a core material that defines a first peripheral edge, heating a localized region proximal to the peripheral edge to a temperature sufficient for remolding the peripheral edge, and extruding the preformed moldable pallet through the at least a one die for reshaping the peripheral edge.

In one aspect of the embodiments of the subject invention, the material of the one or more sheets is substantially the same as the material of the core material, which may be polymeric material.

In another aspect of the embodiments of the subject invention, the peripheral edge is reshaped into a configuration having an arcuate cross section.

In still another embodiment of the subject invention, a pallet includes a core material having a generally cellular configuration, and at least first and second sheets of material (which may be polymeric) spaced apart by the core material thereby defining one or more pallet edges, also referred to as peripheral edges, wherein the one or more pallet edges are each arcuately shaped and sealed to encapsulate the core material.

In yet another embodiment of the subject invention, a molding device for an associated preformed pallet defining one or more peripheral edges and having a cellular core material, includes a generally planar bed, at least one die set mounted to the generally planar bed for extruding the one or more peripheral edges of the associated preformed pallet, wherein the at least one die set has an open side for receiving the associated preformed pallet and wherein the at least one die set is generally concave for remolding the one or more peripheral edges, and wherein the at least one die set is heated to melt or soften the one or more peripheral edges of the associated preformed pallet.

### BRIEF DESCRIPTION OF THE DRAWINGS

FIG. 1 is a partial cutaway perspective view of a pallet according to the embodiments of the invention.

FIG. 2 is a partial perspective view of a pre-formed laminate according to the embodiments of the invention.

FIG. 3 is a partial side view of the pallet according to the embodiments of the invention.

FIG. 4 is a partial cutaway side view of a localized heating apparatus according to the embodiments of the subject invention.

FIG. 5 is a partial cutaway side view of a molding press according to the embodiments of the subject invention.

FIG. 6 is a block diagram of a method of forming a pallet for transporting or storing associated objects according to the embodiments of the subject invention.

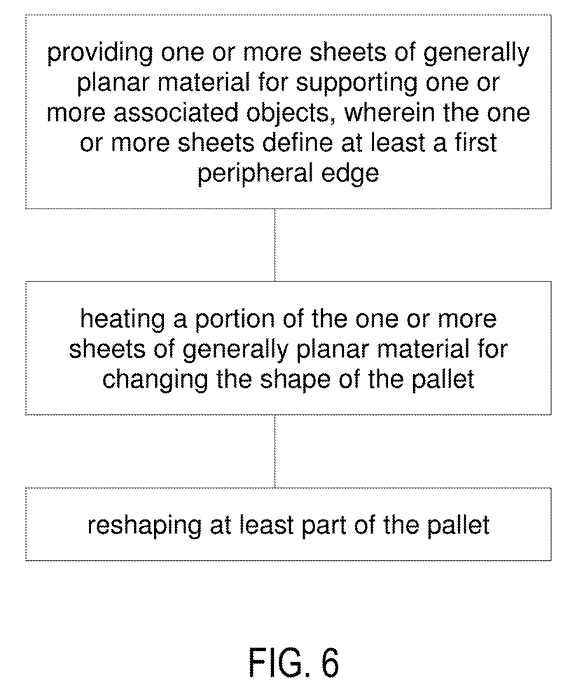

FIG. 7 is a block diagram of a method of forming a pallet made from polymeric material according to the embodiments of the subject invention.

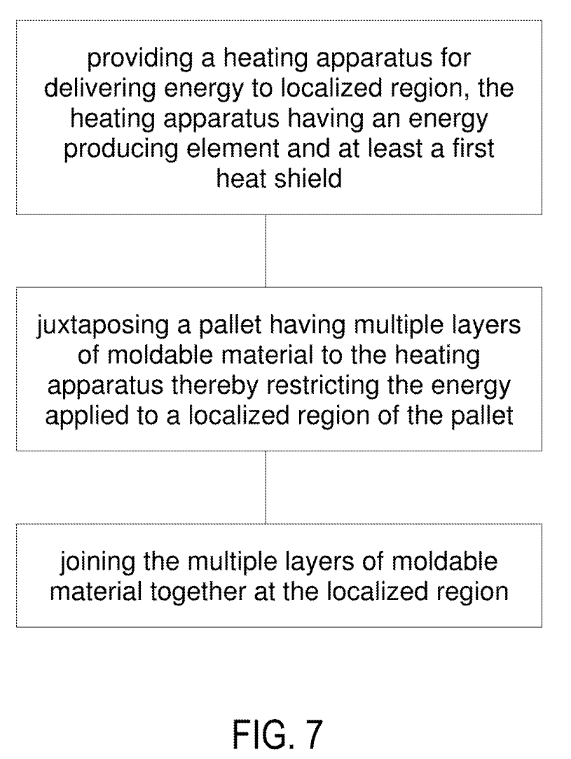

FIG. 8 is a perspective view of another embodiment of the subject invention showing a partially reshaped pallet.

FIG. 9 is a perspective view of a die set for reshaping or reforming the pallet shown in FIG. 8, according to the embodiments of the subject invention.

FIG. 10 is a perspective view of a pallet being reshaped by the die set of FIG. 9, according to the embodiments of the subject invention.

FIG. 11 is a block diagram of a method for reshaping a pallet.

### DETAILED DESCRIPTION OF THE INVENTION

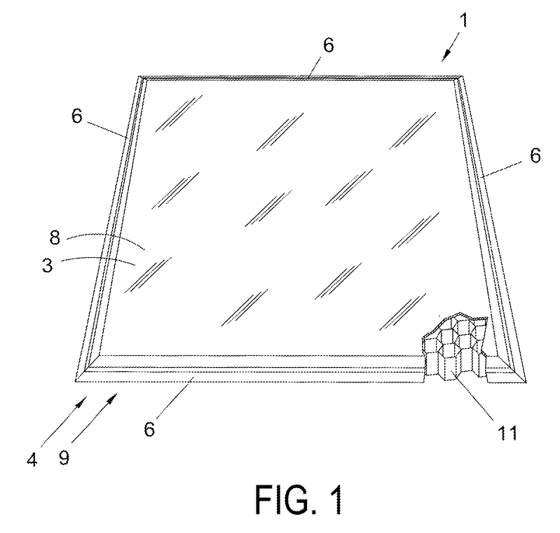

Referring now to the drawings wherein the showings are for purposes of illustrating embodiments of the invention only and not for purposes of limiting the same, FIG. 1 shows a pallet depicted generally at 1. The pallet 1 may be utilized to store and transport goods between locations. One exemplary type of product transported by the pallet 1 may pertain to food related items. However, any type of goods may be loaded onto the pallet 1 and stored or transported as is appropriate for use with the embodiments of the subject invention. The pallet 1 may be generally planar having first and second sides 3, 4. On each of the sides 3, 4, the surfaces may be substantially uniform terminating in pallet edges 6 that may be contoured as will be described in a subsequent paragraph. The pallet 1 may be constructed of a polymer material, such as for example a thermoplastic material. Polypropylene is just one type of a thermoplastic that may be utilized to construct the pallet 1, as it is resistance to bacteria and other contaminants detrimental to sanitary environments like the food processing and packaging industry. It is to be construed that any type moldable material and more specifically moldable plastic may be used to construct the pallet 1 as is appropriate for use with the embodiments of the subject invention. The pallet 1 may have a polygonal configuration, which in an exemplary manner may be substantially square. More specifically, the pallet 1 may be 4 feet by 4 feet in dimension having a thickness in the range between 0.5 inch to 2 inches. However, persons of ordinary skill in the art will readily understand the application of the embodiments of the subject invention to any configuration and/or size of pallet 1.

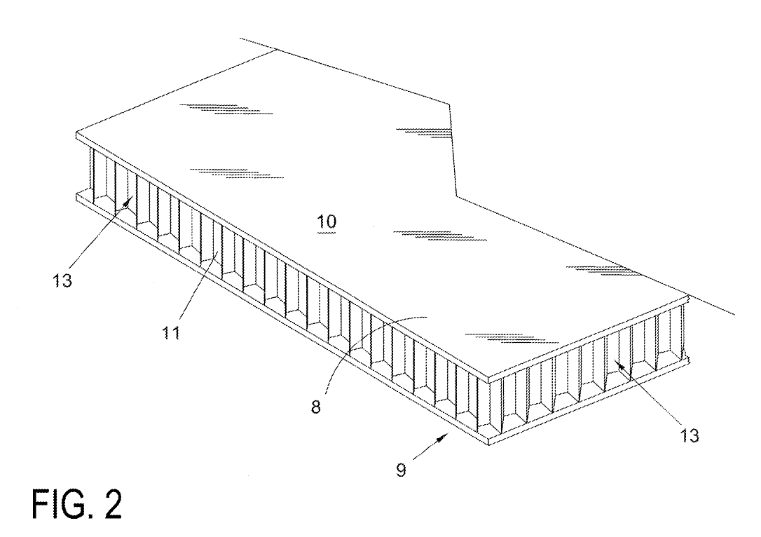

With continued reference to FIG. 1 and now also to FIG. 2, the pallet 1 may be constructed having multiple layers of materials. In one embodiment, all of the layers may be comprised of polymer material, which may be any polymer material having properties suitable for constructing a rigid pallet 1. The layers may include first and second outer layers 8, 9 or skins that sandwich a core 11. The first and second outer layers 8, 9 may be comprised of sheet plastic having a thickness in the range of 0.025 inch to 0.125 inch. The core 11 may be cellular in nature. In particular, the core 11 may have a honeycomb cross section comprising a contiguously formed or monolithic structure. This reduces the overall weight while providing sufficient rigidity for the pallet 1. The core 11 may have a thickness between 0.750 inch to 1.125 inches. Although, it is to be understood that any thickness of the first and second layers 8, 9 and any thickness of core 11 may be chosen with sound engineering judgment. During the formation process, the layers 8, 9, and 11 may be fused by heating and compressing the juxtaposed members together. In one phase of construction, the ends 13 of the layered materials may remain open in preparation for forming the pallet edges 6 in a subsequent process, as will be discussed in detail below. In this manner, the fused first and second outer layers 8, 9 and core 11 having open ends 13 comprise a pre-formed laminate 10.

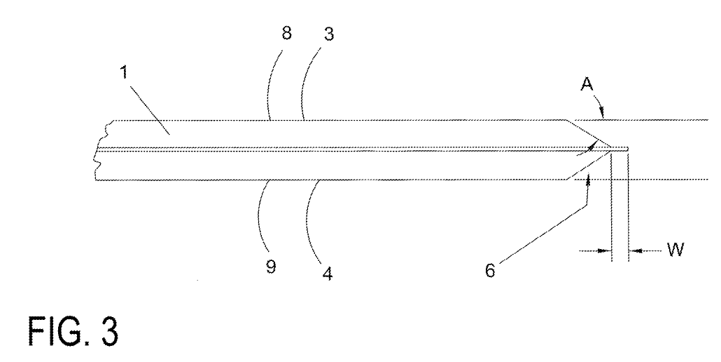

With reference now to FIGS. 1 and 3, in a subsequent forming process, the open ends 13 of the laminate 10 may be fashioned or formed to enclose the core 11. More specifically, the first and second outer layers 8, 9 may be formed so as to encapsulate the core 11 by compressing the open ends 13. In one embodiment, the open ends 13 may be thermoformed and compressed in a mold thereby providing a contoured edge surface, which may be tapered, for easy pick up by tow motor, fork lift or other device. Initially the layers 8, 9, 11 may be fashioned to size and then fused together in a first process thus producing the pre-formed laminate 10. In a subsequent step, a peripheral portion of the laminate 10 may be heated to a temperature, appropriate for softening the type of material being utilized, and subsequently pressure formed thereby compressing and forming the peripheral edge of the pallet 1. In one embodiment, only the peripheral portion of the laminate 10 may be subjected to heat and subsequent compression. That is to say that heat input may be limited to the peripheral portion of the laminate 10. In this way, the edges 6 of the pallet 1 may be thermoformed in a localized manner. This comprises a unique process not known in the art. It will be appreciated by persons of ordinary skill in the art that the distinctive processes of forming the laminate 10 and subsequently forming the pallet 1 may be performed at different locations and/or by different manufacturers. In fact, the pre-formed laminate 10 may comprise a commodity provided to an end-user for subsequently forming the edges 6 in a particular configuration suited to a specific application.

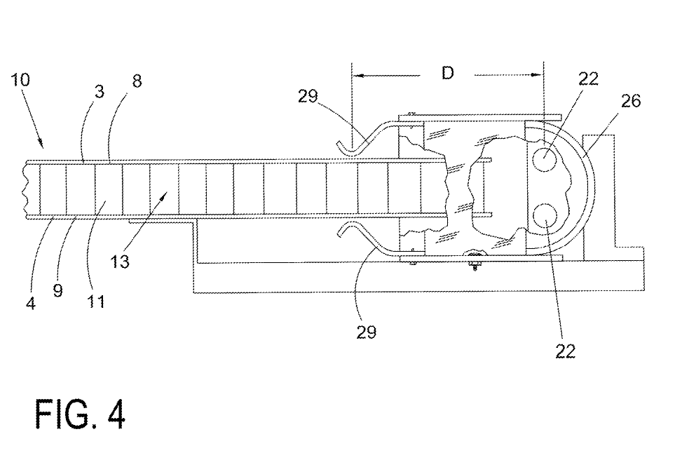

With reference now to FIG. 4, a heating apparatus 18 is provided that will heat a peripheral portion of the laminate 10. The heating apparatus 18 may be generally longitudinal having a length corresponding to the length of the pallet sides. However, any length of the heating apparatus 18 may be chosen as is appropriate for use with the embodiments of the subject invention. The heating apparatus 18 may include one or more heater elements 22 mounted within a housing 26. The heater elements 22 may be of the infrared electric heater type, although other types of heating elements may used without departing from the intended scope of coverage of the embodiments of the subject invention. In one embodiment, the heater elements 22 may be longitudinal infrared heater rods 23 substantially traversing the length of the heating apparatus 18. Heat shields 29 or deflectors may extend from the housing 26 to focus or reflect the heat onto the peripheral portion of the laminate 10. The heating apparatus 18 may include two (2) heat shields extending from opposite sides of the housing 26 for focusing heat onto both sides of laminate 10. In one embodiment, the heat shields 29 may narrow or taper to a thickness proximate to, but slightly larger than, the thickness of the laminate 10. In this manner, the tapered heat shields 29 and the housing 26, which may incorporate a reflective back panel, form a heating chamber 33 into which the peripheral portion of the laminate 10 may be inserted. The depth of the heating chamber 33 may range from between 3 inches to 7 inches. However, any dimension of the heating apparatus components and any depth of the heating chamber 33 may be chosen as is appropriate for use with softening the peripheral portions of the laminate 10. In operation, the heating apparatus 18 may be utilized in one step to form an edge 6 of the pallet 1. This step may comprise heating an outer peripheral band of the laminate 10 to a temperature sufficient to soften the edges thereby allowing it to be formed in a subsequent process as will be discussed in the next paragraph. It is noted here that not only do the heat shields 29 focus heat onto the peripheral portion of the laminate 10, but it also functions to minimize the cooling effect that the surrounding air may have on the laminate 10 while it is being heated.

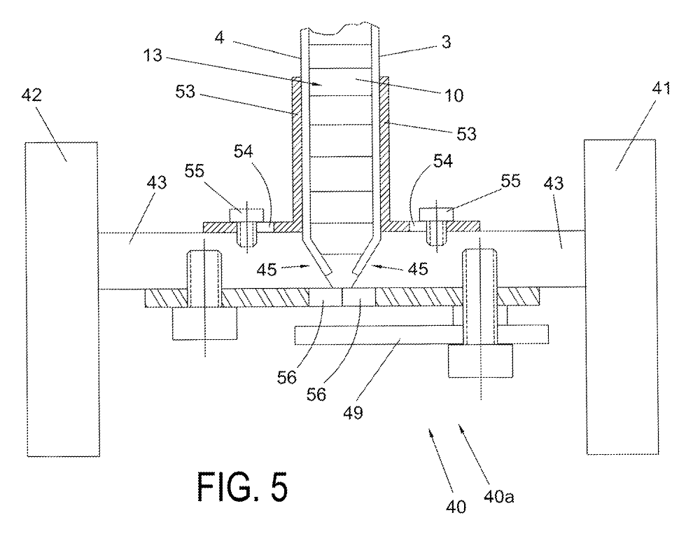

With reference now to FIG. 5, after the peripheral regions of the laminate 10 have been heated, the laminate 10 may be placed into a forming device, shown generally at 40, for compressing and shaping the peripheral portions of the laminate 10 into the pallet edge 6. The forming apparatus 40 may be a molding press 40a, which includes first and second platens 41, 42 movable between minimum and maximum positions. The platens are capable of delivering compression forces for use in forming the edges 6 of the pallet 1. The molding press 40a may be actuated by fluid power, wherein the molding press 40a may comprise a hydraulic molding press 40a. However, it is to be construed that any means may be used to actuate the molding press 40a as chosen with sound engineering judgment. Pinch rails 43 may be used to contact and form the peripheral portions of the laminate 10. Accordingly, the pinch rails 43 may be received by the molding press 40a and positioned between the movable platens 41, 42 for transmitting force to the laminate 10. The pinch rails 43 may have a contoured forming surface 45 for fashioning the edge 6 of the pallet 1. The forming surfaces 45 may be the same for each pinch rail 43 thereby creating a generally symmetrical pallet 1. Alternatively, the forming surfaces 45 of the pinch rails 43 may be substantially different. The contour of the forming surfaces 45 may also have any shape for forming the edges 6 of the pallet 1, like for example but not limited to straight or curved surfaces. In this manner, the heated open ends 13 of the laminate 10 may be placed into the molding press 40a wherein the molding press 40a may be subsequently actuated to close the platens 41, 42 thereby compressing the edges of the laminate 10 into conformity with the surfaces 45 of the pinch rails 43.

The molding press 40a may further include stops 49 positioned between the platens 41, 42 to limit movement of the molding press 40a to a preset position. The stops 49 may be selectively adjustable with respect to the platens 41, 42 and more specifically with respect to the pinch rails 43. In one embodiment, the stops 49 may be rigid members constructed of metal or other material capable of withstanding the compression force of the molding press 40a. It is noted here that other means may also be utilized to selectively limit how far the pinch rails 43 move to compress the edge 6 of the pallet 1. Such embodiments may include but are not limited to electrical controls and sensory feedback that may be used to determine the movement of the platens 41, 42 and pinch rails 43.

With continued reference to FIG. 5, the pinch rails 43 may further include horizontal pinch rail members 53 that are attached to the main pinch rails 43. The horizontal pinch rail members 53 may be selectively adjustable with respect to the pinch rails 43 for optimizing the thickness of the pallet edge 6. The horizontal pinch rail members 53 may include slots or holes 54 and fasteners 55 used to adjust the position of the horizontal pinch rail members 53 with respect to the pinch rails 43. In this manner, the horizontal pinch rail members 53 may function to hold the laminate 10 in position as it is being formed by the molding press 40a. A backstop 56 may also be included to assist the initial placement of the laminate 10 into the molding press 40a. The backstop 56 may also be adjustable with respect to the pinch rails 43 and may function to provide molding pressure to the outside edge of the laminate 10. In this manner, each of the respective pinch rails 43 provide compression forces to the top and bottom of the laminate 10 and the backstop 56 provides compression forces to the end of the laminate 10. In operation, an operator may place the heated preformed laminate 10 into the molding press 40a and subsequently actuate the molding press 40a to engage the surfaces 45 of the pinch rails 43 with the laminate 10. The molding press 40a may then compress the heated end 13 of the laminate 10 thereby forming the edge 6 of the pallet 1 into a configuration corresponding to the contour of the surfaces 45 of the pinch rails 43. It is noted here that the molding press 40a may sufficiently compress the end 13 of the laminate 10 to seal the edge 6 of the pallet 1. That is to say that the molding press 40a may compress and fuse the layers of the laminate 10 thereby sealing the edge 6 of the pallet 1. In an exemplary manner, a 1 inch thick laminate 10 may be compressed down to a thickness of 0.15 inch. However, the molding press 40 a may be capable of compressing the layers of the laminate 10 down to thicknesses in the range of 0.025 inch.

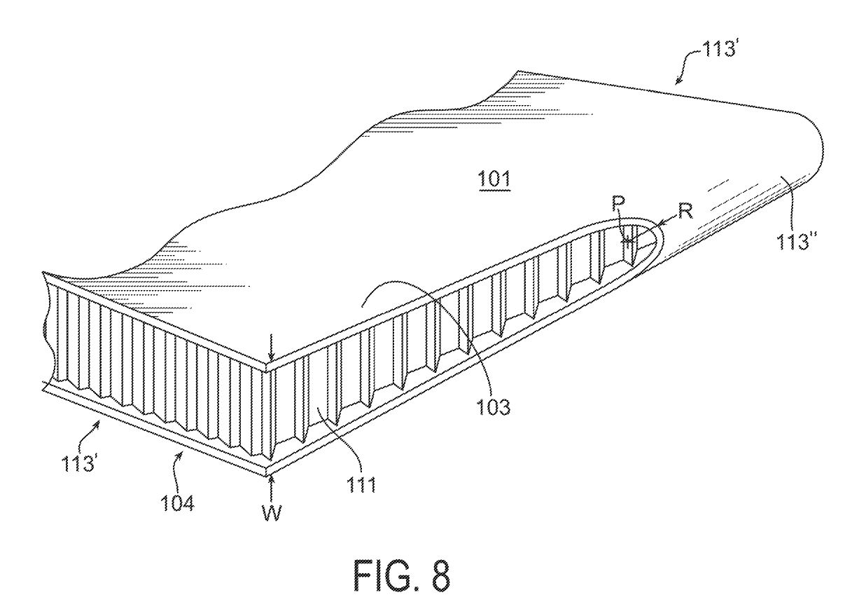

An alternate embodiment of the subject invention will now be discussed. FIG. 8 shows a pallet 101 for storing and transporting goods between locations like that of previously disclosed embodiments. The pallet 101 may be constructed having multiple layers 103, 104, which may be generally planar sheets of substantially homogenous material. The materials comprising the layers 103, 104 may be moldable materials. More specifically, the material making up the pallet layers are capable of being remolded under pressure and/or heat and may include properties like that of thermoplastic materials. One example of a material making up the layers 103, 104 is polypropylene. However, any type of moldable material may be used that does not substantively degrade the pallet's ability to store and transport goods when remolded.

In one embodiment, the pallet 101 may comprise first and second layers 103, 104, or sheets, of material separated by a core 111 of reinforcing material. The core 111 may not be uniformly dense, but rather may be generally cellular in makeup, having pockets or cavities of air or other less dense material incorporated therein. While any configuration of a cellular core material may be utilized, generally the core configuration is honeycomb shaped, i.e. the cells have a honeycomb cross section. It is noted that while the density of the core 111 may not be uniform as a result of including cellular pockets, the spacing of the individual cells may be uniform throughout the pallet 101. Thus, the juxtaposition of the layers 103, 104 and core 111 forms a pallet 101 having open edges or boundaries, i.e. an exposed core.

It is noted here that the material comprising the layers 103, 104 may be substantially the same as the material comprising the core 111, which as previously mentioned may be polypropylene. However, different materials may be used in constructing the layers 103, 104 and the core 111 respectively.

The components of the pallet 101, i.e. layers 103, 104 and core 111, may be initially affixed together, or fused together, prior to reshaping or remolding the boundaries of the pallet 101, which pertains to the subject matter of the present embodiment. In this way, the pallet 101 is preformed or preassembled. Still, other embodiments are contemplated wherein the layers 103, 104 are affixed to the core 111 after reshaping the outer boundaries of the pallet 101, or are not affixed together at all. In any case, the outer boundaries of the pallet 101 define peripheral edges 113, which may be reshaped and closed or sealed thereby covering the exposed core 111. For discussion purposes, the peripheral edges 113 may be, at times, referred to in pairs of distally opposed edges 113′, 113″ respectively.

Still referencing FIG. 8, the peripheral edges 113 of the pallet 101 may be reshaped, and more particularly remolded to a configuration that is generally rounded or arcuate in shape, which may include polygonal contours. The remolding process may also enclose the open edges of the pallet 101 encapsulating the core 111 material. In one particular embodiment, the rounded edges 113 may be uniformly rounded. In other words, the arcuate shape of the remolded edges 113 may have a constant radius, as measured from a center point P, that begins at a first layer 103 or 104 and extends to the second layer 104 or 103. In another embodiment, the edges 113 may be arcuately shaped but defined by multiple radii extending from spaced apart center points, or even multiple radii of different lengths extending from the same center point P. It will be readily seen that such embodiments result in a rounded but tapered cross sectional configuration, or otherwise oblong configuration. Still, it is to be construed that any rounded or arcuately shaped edge 113 may be formed on the periphery of the pallet 101 as chosen with sound engineering judgment.

Accordingly, the pallet 101 may be heated at a localized region proximal to the peripheral edges 113 to facilitate reshaping the peripheral edge(s) 113. In one embodiment, the localized region of the pallet 101 extends inwardly from the peripheral edge 113 by a distance equal to the thickness T of the pallet 101. However, the localized region, i.e. the distance from the peripheral edge 113, may be greater or less than the thickness T. More specifically, the localized region may be defined through a range of distances extending from substantially 1/10 of the pallet thickness T up to 3 times the pallet thickness. Still, greater thicknesses may be defined as is suitable for reshaping the peripheral edge 113 of pallet 101.

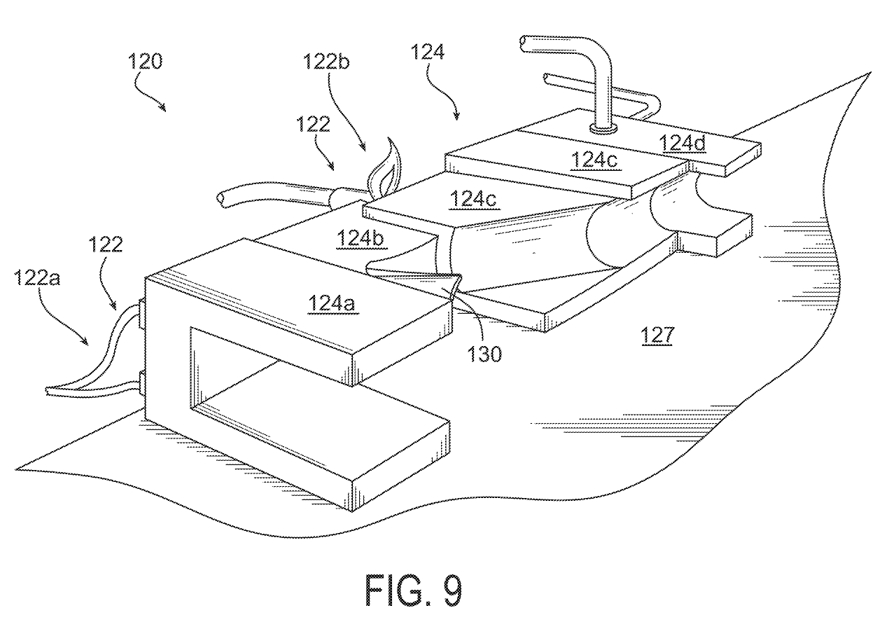

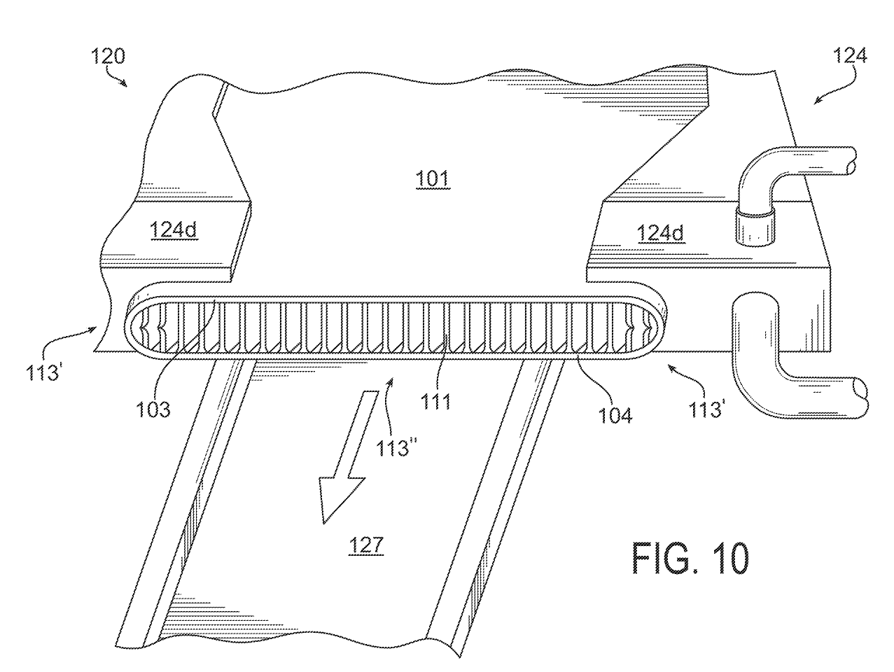

Referring to FIGS. 9 and 10, to reshape the peripheral edge 113, the pallet 101 may be directed or placed into a molding device 120 having the capability to heat the localized region so described above. The molding device 120 may include a die set 124 that extends around the peripheral edge(s) 113′, 113″ of the pallet 101. The die set 124 may be mounted to a bed or base 127 that provides support for the die set 124 during the reshaping process, to be described in detail below. In one embodiment, the dies set 124 heats the pallet 101 only at the localized region. In this way, the reshaping or remolding of the peripheral edge(s) 113′, 113″ does not affect, i.e. melt, the remainder of the pallet 101.

The die set 124 may include one or more die set sections 124a, 124b, etc., which may be segmented by function and/or configuration for changing the shape of the peripheral edge(s) 113′, 113″. The die set sections may be contiguously formed as a singular die. Alternatively, the die set 124 may be comprised of individual die set sections adjacently positioned and affixed together securely onto the bed 127. Still, any number of and any manner of forming the die set 124 may be chosen with sound judgment. It is also contemplated that the die set 124 and/or die set sections 124a-124d, as shown in FIG. 9, may be adjustably connected with respect to the bed 127. By adjustably connected it is meant that the die set 124 may be moved around on the surface of the bed 127 for receiving pallets 101 of different sizes.

The material comprising the die set 124 may be generally rigid material like for example aluminum, or other metal or metal alloys. Materials may be chosen that readily transfer heat, which may be directly applied to and/or drawn away from the pallet 101 during the reshaping or remolding process. Still, any material for constructing the die set 124 and/or the die set sections 124a-124d may be chosen as is appropriate for use with the embodiments of the subject invention.

In one exemplary manner, the die set 124 may include a first die set section 124a that may be heated for softening or melting the pallet 101, at the localized region, in a first stage of the reshaping or remolding process. The first die set section 124a may be generally concave, having an open end for receiving a peripheral edge 113 of the pallet 101. Its thickness may be proportionate to the thickness T of the pallet 101. In one embodiment, the first die set section 124a may have an adjustable thickness for accommodating pallets of different thicknesses. Any manner of adjusting the width of the die set sections 124a through 124d may be chosen with sound judgment.

The first die set section 124a may be heated to a temperature suitable for softening the particular material used to construct the pallet 101. Accordingly, the molding device 120 may include one or more heating elements, shown generally at 122. Heat may be supplied to the first die set section 124a by one or more means including but not limited to electrical resistance 122a, direct flame 122b, radiation, or other means known in the art. Additionally, heat applied to the first die set section 124a may be varied as managed by a heat controller, not shown, to raise its temperature through a range extending from between 100 degrees Fahrenheit to 1000 degrees Fahrenheit dependant on the material used in constructing the pallet 101. In one exemplary embodiment, the die set section 124a may be heated to a temperature of 800 degrees Fahrenheit for reshaping polypropylene. Still, temperatures in excess of 1000 degrees Fahrenheit are to be construed as falling within the scope of coverage of the appended claims as required for materials having higher melt temperatures. In this way, the molding device 120 is adjustable for reshaping pallets constructed of different types of materials.

As stated, heat delivered to the die set section 124a is transferred to the pallet 101 for the reshaping process. As such, energy is to be applied at a particular rate, which may be constant or variable. Accordingly, the heat controller, not shown, may function (with or without feedback) to regulate the temperature of the die set section 124a by controlling the rate at which energy is delivered. In this manner, the function of the first die set section 124a is primarily to apply heat to the pallet 101 for softening or melting the peripheral edge 113.

With continued reference to FIG. 9, one or more subsequent die set sections, like die set section 124c, may be used to reshape the softened or melted material of the peripheral edge 113. Accordingly, its cross section may be contoured like that described above for the edges 113 of the pallet 101. Accordingly, the contour of the die set section 124c may be arcuately shaped having a constant, or changing, radius of curvature. Persons of skill in the art will readily see that the softened material of the peripheral edge 113 will conform to the shape of die set section 124c under pressure. It is expressly noted that the die set section 124c may be heated like that of the previous die set section 124a, although at lower temperature. This helps maintain the softened characteristic of the peripheral edge material during the reforming process, without degrading the material or melting it too much. In the exemplary embodiment described above for polypropylene, the temperature of die set section 124c may range from between 300 and 400 degrees Fahrenheit, and more specifically may be approximately 350 degrees Fahrenheit. Thus, it will be appreciated that as the pallet 101 is progressively forced into contact with the die set 124, the layers of the peripheral edge(s) 113 blend together and are reshaped to the contour of die set section 124c.

With continued reference to FIG. 9 and now to FIG. 10, another die set section 124d may be included that assists in reforming the pallet by cooling the softened and reshaped peripheral edge 113. Die set section 124d may have the same or similar contour as that of the previous die set section 124c, but instead of applying heat may include means for drawing heat out of the pallet material. The rigidity of die set section 124d maintains the shape of the newly reformed peripheral edge 113 while it cools and consequently solidifies the material.

To facilitate cooling, die set section 124d may contain or be filled with a cooling medium. In one embodiment, the cooling medium may be a fluid like water or other liquid. Alternatively, the cooling medium may be gaseous, like for example air. However, any cooling medium may be chosen that suitably draws heat away from the die set 124 and consequently the peripheral edge(s) 113 of the pallet 101. Accordingly, die set section 124d may include one or more internally fashioned conduits 133 that channel the cooling medium to and from its source, not shown in the figures. The one or more internally fashioned conduits may connect with externally mounted conduits or tubes 134 for cycling the cooling medium in a manner well known in the art. Alternate embodiments may include direct cooling on the outer surface of the die set section 124d, as may be accomplished by the turbulent flow of air. In this manner, the die set 124 is actively cooled by the positive flow of a cooling medium through or across its surfaces. Still, any manner for lowering the temperature of die set 124 or die set section 124d may be chosen with sound engineering judgment.

Referencing FIG. 9 once again and another embodiment of the subject invention, as the material comprising the peripheral edge 113 melts or softens, force from pushing the pallet 101 through the die set 124 folds or overlaps the moldable material upon itself fusing the layers 103, 104 and core 111 material together. To assist in conjoining the materials, another die set section 124b may be incorporated between sections 124a and 124c. This section 124b may include a rigid member 130 that extends into the pathway of the extruded pallet 101 at the region of the peripheral edge 113. The rigid member 130 may function to separate or divide the core 111 material into segments thereby assisting the reforming process accomplished by the subsequent die set sections. Any shape and/or extending length of the rigid member 130 may be chosen as is useful for fusing the layers 103, 104 and core 111 together.

FIG. 10 shows yet another embodiment of the subject invention. In this embodiment, the molding device 120 may include multiple die sets 124. The multiple dies sets 124 may be mirror images of each other. Stated differently, the molding device 120 may include matching die sets 124 that are symmetrically mounted on the bed 127 for extruding first and second peripheral edges 113′ at substantially the same time. In this way, the preformed pallet 101 may be forced, or extruded, through the molding device 120 in a first step, thereby reforming one set of distal edges 113′, and subsequently in a second step forming another set of distal edges 113″. It is noted that the position of the die sets 124 may be adjustable, i.e. adjustably mounted to the bed 127, for accommodating pallets having different widths.

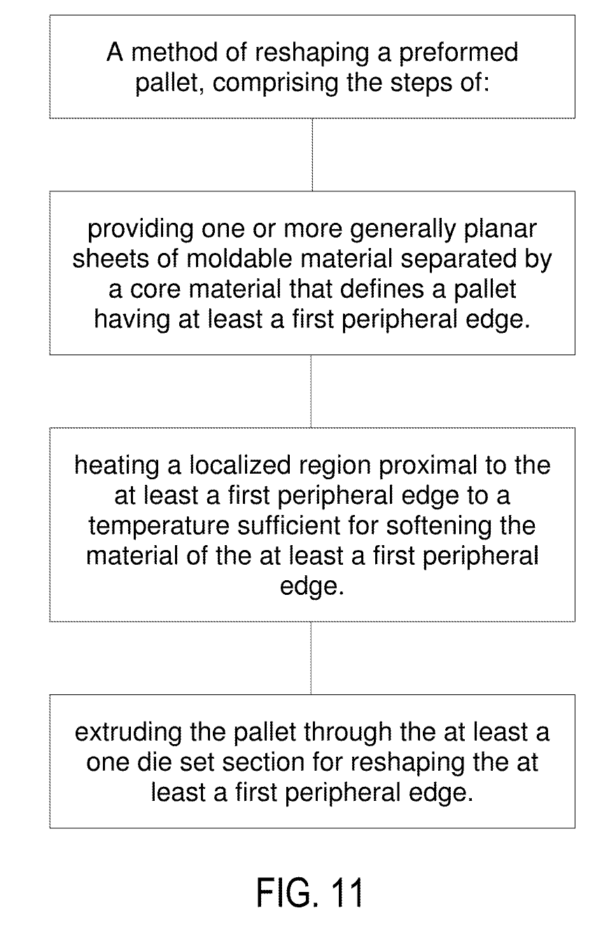

With reference now to FIGS. 8 through 11, the process of the reshaping will now be described. The die sets 124 may be adjusted positionally for accommodating a particular width of pallet 101 and turned on or activated wherein heat is directed into or away from the die set sections in a manner consistent with that described above. Once set at the proper temperature, the pallet 101 may be drawn through the molding device 120 at a rate suitable for melting, reshaping and cooling the peripheral edges 113′ of the pallet 101. Once completed, the pallet 101 may then be rotated and the peripheral edges 113″ drawn through the molding device 120 in a similar manner.

The invention has been described herein with reference to the preferred embodiment. Obviously, modifications and alterations will occur to others upon a reading and understanding of this specification. It is intended to include all such modifications and alterations insofar as they come within the scope of the appended claims or the equivalence thereof.

What is claimed is:

1. A method of reshaping a preformed pallet, comprising the steps of:
providing one or more generally planar sheets of moldable material separated by a core material that defines a pallet having at least a first peripheral edge;
heating a localized region proximal to the at least a first peripheral edge to a temperature sufficient for softening the material of the at least a first peripheral edge; and,
extruding the pallet through the at least a one die set section for reshaping the at least a first peripheral edge.

2. The method as defined in claim 1, wherein the one or more generally planar sheets of moldable material and the core material are each comprised of a moldable polymeric material; and,
wherein the polymeric material of the one or more sheets is substantially the same as the polymeric material of the core material.

3. The method as defined in claim 2, wherein the polymeric material is a thermoplastic material.

4. The method as defined in claim 2, wherein the one or more generally planar sheets of moldable material is fused to the core material prior to heating the localized region.

5. The method as defined in claim 1, wherein the core material has a cellular configuration including a plurality of juxtaposed cells, and,
wherein the at least a first peripheral edge is reshaped into an arcuate cross section.

6. The method as defined in claim 5, further comprising the step of:
separating at least a portion of the plurality of juxtaposed cells into cell segments prior to reshaping the at least a first peripheral edge of the pallet.

7. The method as defined in claim 5, wherein the plurality of juxtaposed cells have a honeycomb cross section.

8. The method as defined in claim 1, wherein the step of extruding the pallet through at least a one die set section for reshaping the at least a first peripheral edge, comprises the step of:
extruding the pallet through at least a one die set section for reshaping the at least a first peripheral edge, wherein the at least a first peripheral edge of the pallet is sealed to encapsulate the core material.

9. The method as defined in claim 1, wherein the pallet includes multiple edges, and wherein all of the multiple edges are reshaped by extruding the preformed moldable pallet.

10. A pallet, comprising:
a core material having a generally cellular configuration; and,
at least first and second sheets of polymeric material spaced apart by the core material defining one or more peripheral edges, wherein the one or more peripheral edges are each arcuately shaped and sealed to encapsulate the core material.

11. The pallet as defined in claim 10, wherein the generally cellular configuration has a honeycomb cross section.

12. The pallet as defined in claim 10, wherein the core material is constructed from a polymeric material; and,
wherein the polymeric material of the at least first and second sheets is substantially the same as the polymeric material of the core material.

13. The pallet as defined in claim 12, wherein the polymeric material is a thermoplastic material.

14. The pallet as defined in claim 12, wherein the polymeric material is polypropylene.

15. A molding device for an associated preformed pallet defining one or more peripheral edge and having a cellular core material, comprising:
a generally planar bed; and,
at least one die set mounted to the generally planar bed for extruding the one or more peripheral edges of the associated preformed pallet, wherein the at least one die set has an open side for receiving the associated preformed pallet and wherein the at least one die set is generally concave for remolding the one or more peripheral edges; and,
wherein the at least one die set is heated to melt the one or more peripheral edges of the associated preformed pallet.

16. The molding device as defined in claim 15, wherein the at least one die set is segmented into die set sections; and,
wherein less than all of the die set sections are heated to an elevated temperature for melting the at least one peripheral edge of the associated preformed pallet.

17. The molding device as defined in claim 15, wherein the at least one die set is segmented into die set sections; and,
wherein a portion of the die set sections are actively cooled for solidifying the one or more peripheral edges of the associated preformed pallet.

18. The molding device as defined in claim 15, wherein the at least one die set is segmented into die set sections; and,
wherein a portion of the die set sections include one or more internal cavities for receiving a cooling fluidic material for drawing heat away from the one or more peripheral edges of the associated preformed pallet.

19. The molding device as defined in claim 15, wherein the at least one die set mounted to the generally planar bed for extruding the one or more peripheral edges of the associated preformed pallet, comprises:
first and second die sets symmetrically mounted to the generally planar bed for extruding the multiple peripheral edges of the associated preformed pallet at substantially the same time.

20. The molding device as defined in claim 19, wherein the position of the first die set is adjustable with respect to the second die set for extruding preformed pallets of different sizes.
